(19) United States
(12) Patent Application Publication
(10) Pub. No.: US 2025/0174114 A1
(43) Pub. Date: May 29, 2025

(54) Remote Positioning System (RPS)

(71) Applicant: Christopher Ward, Etowah, TN (US)

(72) Inventor: Christopher Ward, Etowah, TN (US)

(21) Appl. No.: 18/523,782

(22) Filed: Nov. 29, 2023

(51) Int. Cl. G08C 17/02; G08C 25/02

(52) U.S. Cl. CPC G08C 17/02; G08C 25/02; G08C 2201/10; G08C 2201/42

(57) ABSTRACT

The Remote Positioning System is a precision measuring device which monitors exact, real time positioning, while allowing mobility through the elimination of power and communication wiring; thus, permitting the ability to continuously rotate, articulate, and traverse in multiple axes simultaneously, while maintaining precise location without the restrictions of limited movement due to wiring.

### FIELD OF THE INVENTION

The present invention is related to providing the ability to precisely track the position of an item while eliminating existing restrictions that prevent unconstrained mobility.

### BACKGROUND OF THE INVENTION

The creative design of the Remote Positioning System (RPS) is inspired by the need for increased accuracy, efficiency, and safety of the current processes of position monitoring associated with various in-place machining equipment. Currently, machines of such nature, most often utilize the traditional method of markings on a handle or a fixed scale, in which one must mentally maintain position in correlation with the graduations on the handle or fixed scale. Additionally, one may choose to use a travel indicator fixed, magnetically or mechanically, given conditions permit; however, even if possible, the current methods pose potential for safety concerns as well as potential errors due to the indicator that is trying to be read which is constantly rotating with the machine in some situations. Other concerns may be the ability to stay a safe distance away from the work (or the item being monitored) as much as possible due to temperature, flying debris, or radiation exposure in proximity, etc. The wireless monitor and the lack of the need for a power cord allow for the added layer of safety. This Remote Positioning System (RPS) can be applied to many applications requiring precision position monitoring with the need to be physically unrestricted by wires.

### BRIEF DESCRIPTION OF THE FIGURES

The following further describes the details in the provided figures and component parts.

FIG. 1 shows an (RPS) enclosure along with a cover and one Adapter/Bluetooth receiver as well as one Rechargeable battery bank.

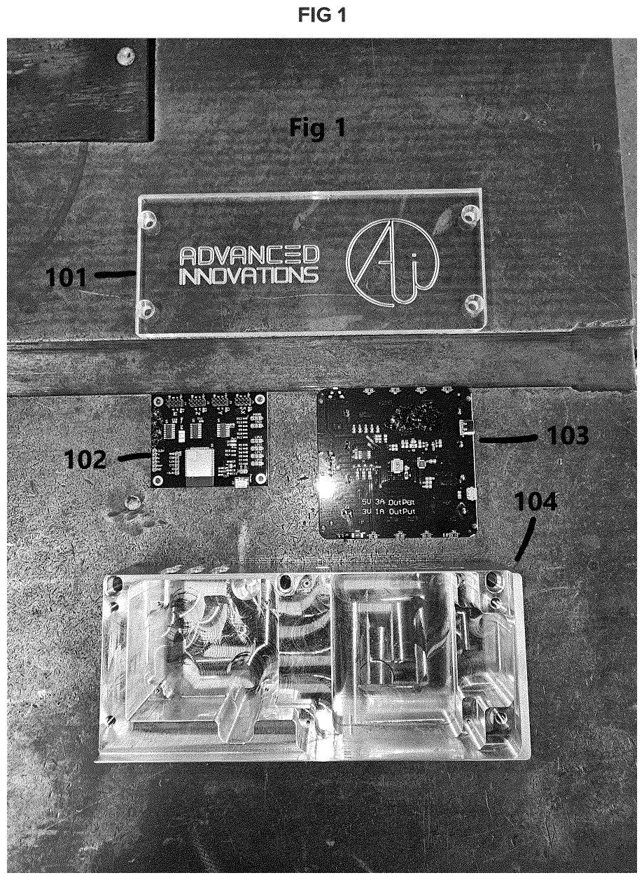

FIG. 2 shows a top view of an enclosure with the Adapter/Bluetooth receiver and Rechargeable battery bank installed.

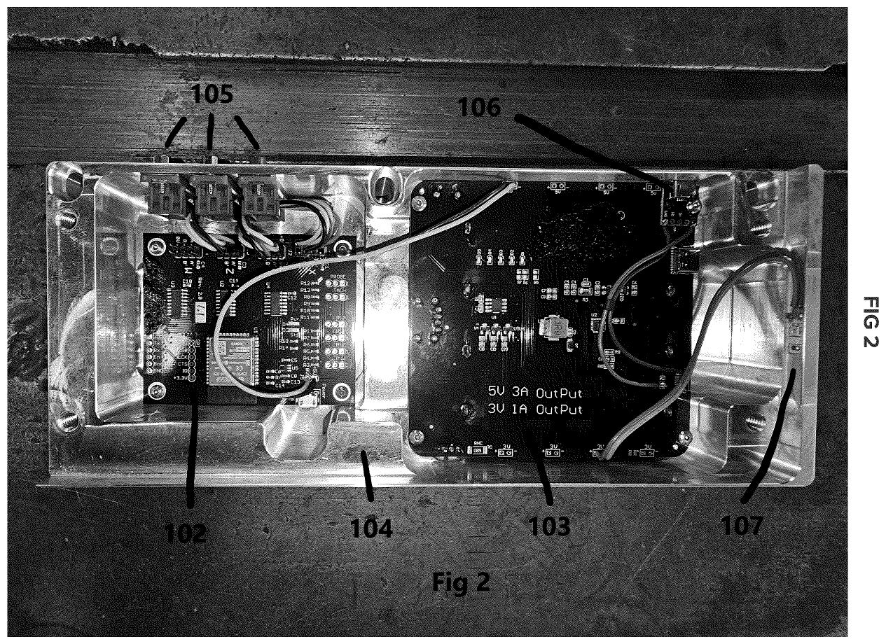

FIG. 3 shows an isometric view of FIG. 2.

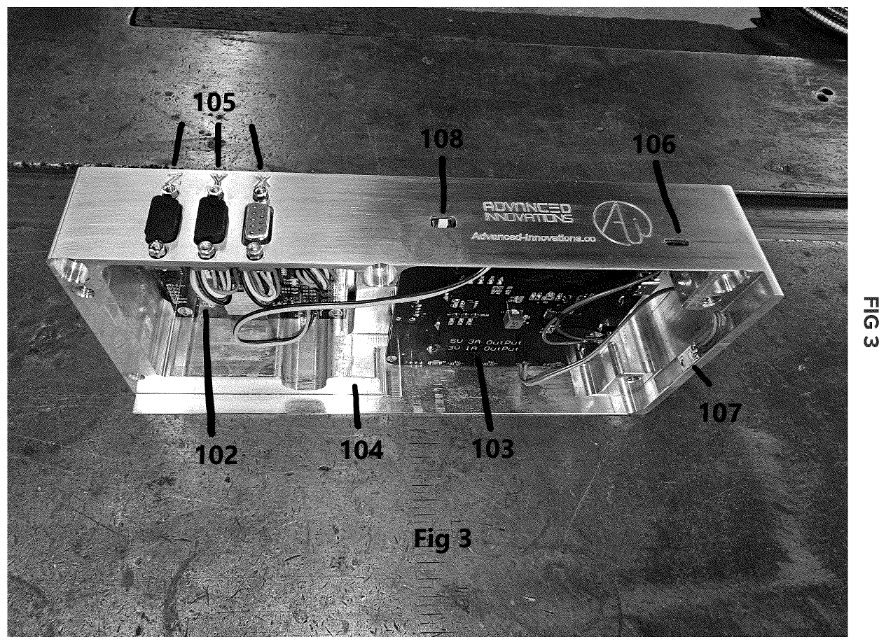

FIG. 4 shows a linear digital encoder.

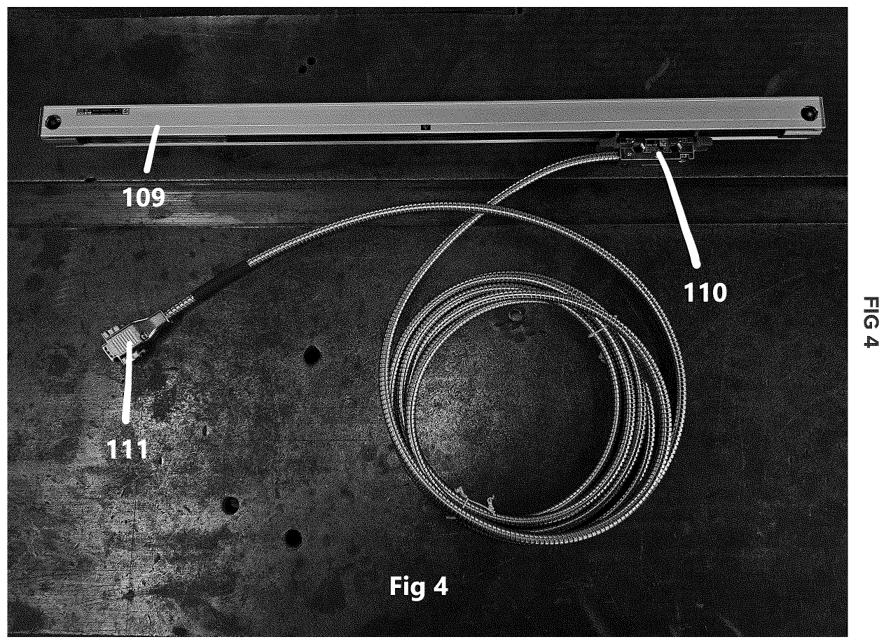

FIG. 5 shows an assembled enclosure with a linear digital encoder connected.

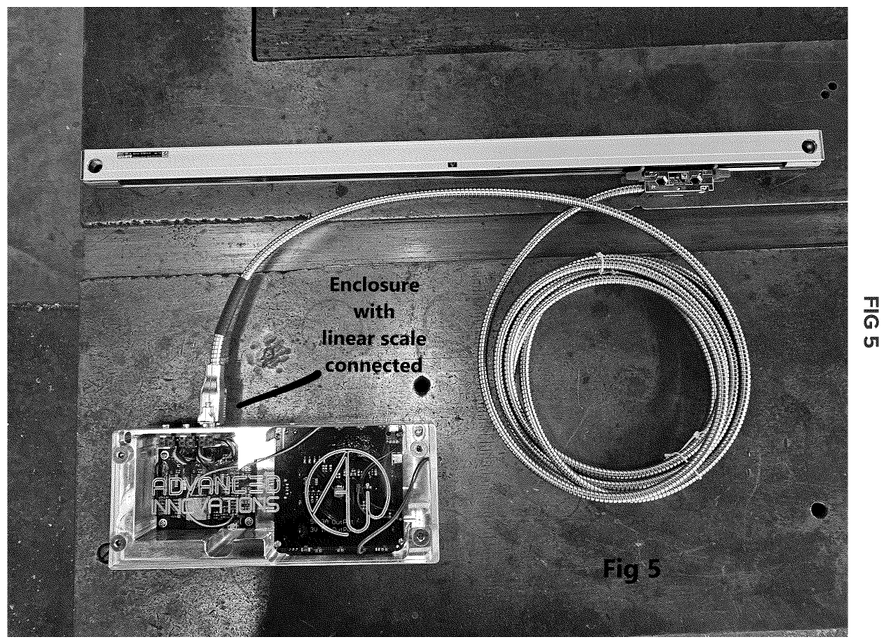

FIG. 6 shows a Bluetooth capable monitor.

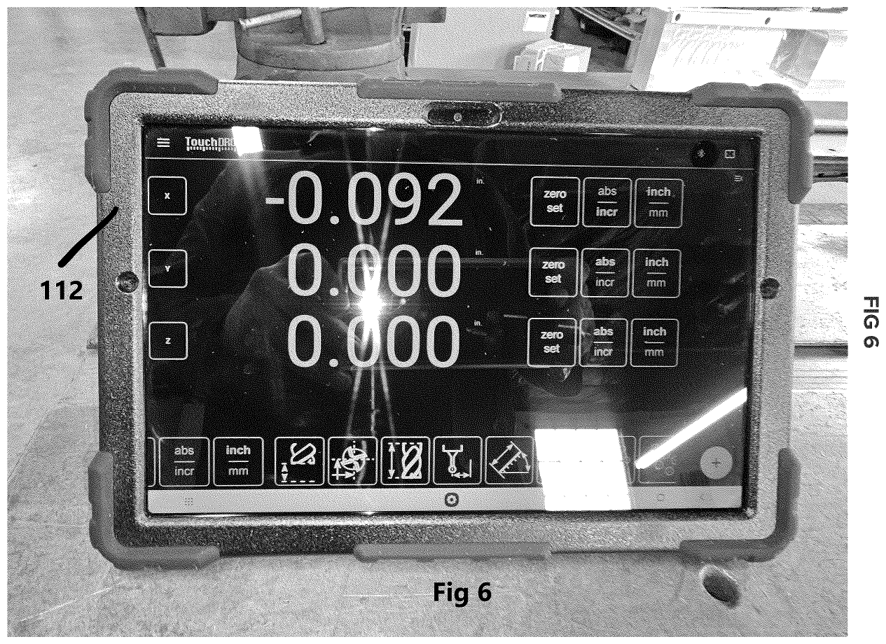

FIG. 7 shows a complete assembled unit, with one linear encoder (for one axis), connected to the unit along with the Bluetooth capable monitor.

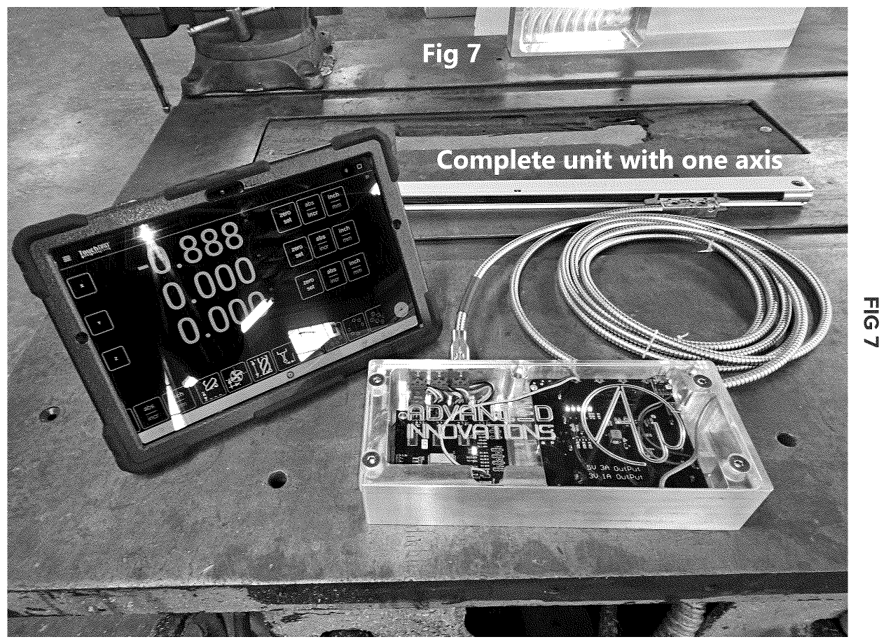

FIG. 8 shows a complete assembled unit, with one low profile linear encoder, mounted to the top of an extended enclosure as an example of one configuration.

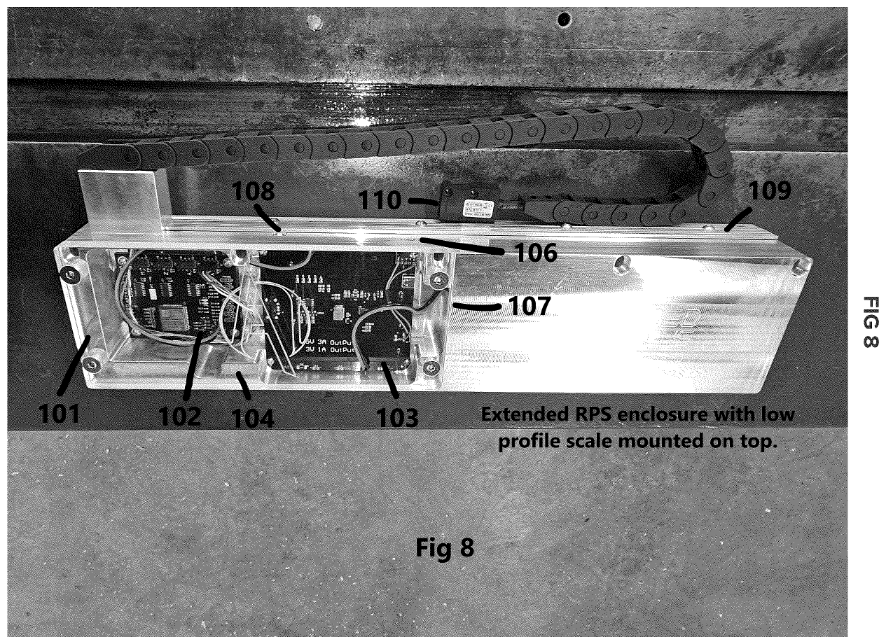

FIG. 9 shows a machine tool in which an (RPS) could be installed as one example of an application.

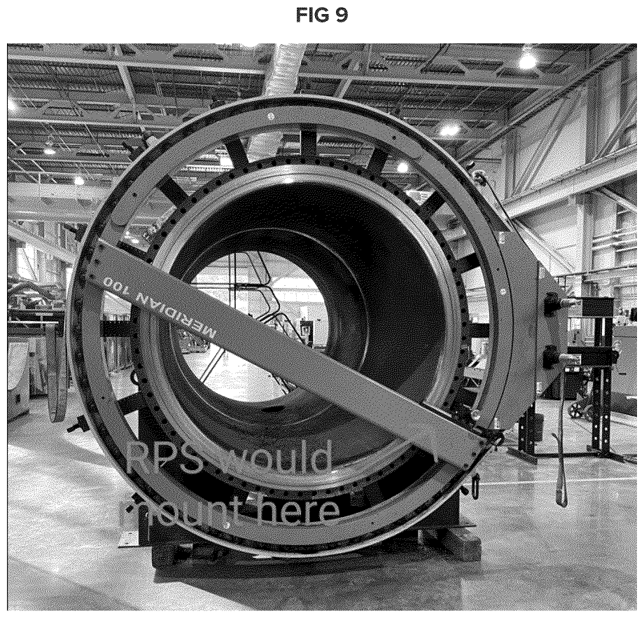

### COMPONENT PARTS OF THE REMOTE POSITIONING SYSTEM

The descriptions of the components are as follows:

| | |
|---|---|
| 101. | Enclosure cover |
| 102. | Adapter/Bluetooth transmitter |
| 103. | Rechargeable battery bank |
| 104. | RPS enclosure |
| 105. | Female DB9 scale connector |
| 106. | Charging port |
| 107. | LED |
| 108. | Power button |
| 109. | Linear scale |
| 110. | Scale reader |
| 111. | Male DB9 scale connector |
| 112. | Bluetooth capable monitor |

### Detailed Description of the Remote Positioning System

The following is a detailed explanation of the Remote Positioning System (RPS).

Rechargeable battery bank (103) supplies power to Adapter/Bluetooth transmitter (102). As an item connected to Scale (109) is moved, Scale (109) is moved across Reader (110). Reader (110) sends an electrical signal to Adapter/Bluetooth transmitter (102). Adapter/Bluetooth transmitter (102), connected to Bluetooth capable monitor (112), communicates real time position wirelessly and is displayed as a digital interface allowing connected item to rotate, articulate, traverse, etc, freely while also allowing the item to be precisely monitored remotely. With additional encoders, (linear or rotary), multiple axes can be monitored simultaneously. (109) and (110) are components of a digital encoder.

Note: In layman's terms, if an object is connected to an encoder, (linear or rotary), as it moves, it is moving a functional part of that encoder which transmits a signal to something else that's going to read it. The signal can then be turned into data that's readable by humans. Generally some form of a digital readout. If multiple encoders are attached to that object, the position of multiple directions can be monitored as the object is moving in each direction. The size and type of encoder used (e.g., glass, magnetic, capacitive) would be determined by the application.

In this design, it is the intention to overcome the limitations of movement that are caused by the power cord and monitor communication wires that prevent us from using the positioning systems that are currently used on traditional stationary machines. This will allow machines that need to rotate or move without wires, to have a digital readout installed on them. The Remote Positioning System can be applied to subtractive machining, additive machining, welding machines, torch or plasma cutting machines, measuring machines, feature mapping machines, or anything else that one might wish to precisely monitor the position of, that needs to move freely.

### Application of Remote Positioning System

The availability of the Remote Positioning System will greatly aid in advancing current machining processes; as well as benefit many other applications requiring precision position monitoring that demand unrestricted mobility; with respect to safety, quality, and efficiency. With the vast variety of encoders available today, one can combine the proper combination with the design proposed, and overcome many of the current limitations of today, while simultaneously creating a much more productive, accurate, and safe workplace.

### A. Subtractive Machining Example

In a machining scenario one might have a Remote Positioning System (RPS) installed on a flange facing machine; in which to monitor the X and Z axes. The intention here is to precisely control the placement of the cutting tool to achieve desired results while machining a component to a blueprint or drawing.
The machine tool would be mounted onto the component to be machined. Having a tool that would rotate continuously (as the principle of a lathe with the tool rotating instead of the part) mounted on linear guides in two perpendicular axes allowing for positioning of the cutting tool (bit). Utilizing some form of linear encoder, the X axis linear guide would have the Z axis linear guide mounted on its carriage plate perpendicular to its ways. The Z axis linear guide would have the tool and holder mounted on its carriage plate. Both axes would have a linear encoder mounted to their ways while having the linear encoder reader mounted to their carriage plates. As the bit is moved in either axis, the carriage plate moves the reader across the scale sending a signal to the Adapter/Bluetooth transmitter. The Adapter/Bluetooth transmitter sends the signals to the monitor which displays the positions in real time.

### B. Plasma Cutting Example

This scenario gives an example of a plasma cutting machine with a Remote Positioning System installed; in which to monitor one linear axis (Z), and one rotary axis (W) so that a square hole could be cut out of the side of a piece of pipe.
A rotary slide way (axis W) would be fitted with a rotary encoder (same as linear encoder but configured as a radius instead). The rotary slide carriage would be fitted with the encoder reader. The plasma torch would be mounted on a linear slide carriage which would be fitted with a linear reader. The linear slide carriage would be mounted on the linear slide ways which would be fitted with a linear encoder. As the torch is moved in the Z axis, the linear reader would send the signal to the Adapter/Bluetooth transmitter and the Adapter/Bluetooth transmitter would send the signal to the Monitor which would display the position as the torch moves along the Z axis. Upon approaching the end of the linear move, the torch would begin to rotate in the W axis. The W axis reader would send the signal to the Adapter/Bluetooth transmitter and then it would communicate the rotational position with the monitor. This would allow, for example, someone to precisely cut out a 6″×10″ square hole in a 24″ piece of pipe with a plasma cutting machine.

In an attempt to express the unlimited movement in a similar scenario, it would be possible to use the plasma cutting machine to cut a spiral around and around the pipe from one end to the other.

It is claimed:

1. A remote positioning system comprising:
a. a digital encoder comprising a linear or rotary scale and a reader head for attaching to an object wherein as the object is moved along the axis of the scale, a digital signal is communicated;
b. a battery powered receiver/transmitter for receiving the signal from the digital encoder wherein a wireless signal is then transmitted;
c. a wireless monitor for receiving the signal then converting it into readable data for maintaining position of the continuously rotating object.

2. The remote positioning system according to claim 1 wherein the number, size, and configuration of axes and enclosure will change depending on the application.
